(19) United States
(12) Patent Application Publication
(10) Pub. No.: US 2006/0280099 A1
(43) Pub. Date: Dec. 14, 2006

(54) Optical element and optical pickup apparatus

(75) Inventor: Shuji Murakami, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/438,341

(22) Filed: May 23, 2006

(30) Foreign Application Priority Data
May 25, 2005 (JP) 2005-152306

(51) Int. Cl. G11B 7/135

(52) U.S. Cl. 369/112.2

(57) ABSTRACT

An object of the invention is to suppress adherence of dust or stain due to the environment and provide an optical element that can maintain optical characteristic for a long period of time, and achieve high durability and reliability. It is also another object of the invention to provide an optical pickup apparatus with good pickup characteristic, using the optical element. Disclosed is an optical element, including: plastic compound, wherein charging characteristic of the optical element is not less than +2 kV and not more than +15 kV, and transmission of the optical element for a light flux having a wavelength of 405 nm is not less than 85%.

### BACKGROUND OF THE INVENTION

1. Field of the Invention

The present invention relates to a plastic optical element and an optical pickup apparatus using the plastic optical element.

2. Description of Related Art

Conventionally, devices to read and record information, such as a player, a recorder, a drive, and the like, are provided with an optical pickup apparatus for an optical information recording medium (hereinafter referred to as “medium”) such as MO, CD, DVD, and the like. The optical pickup apparatus is provided with an optical unit, which irradiates to the medium, a light of predetermined wavelength irradiated from a light source, and receives reflective light with a light receiving element. The optical unit includes optical elements such as a lens to condense these lights to reflective layer of the medium and the light receiving element.

It is preferable to use plastic material for the optical element of the optical pickup apparatus, in terms that it can be manufactured inexpensively by injection molding and the like. As for plastic that can be applied to optical element, copolymer of cyclic olefin and α-olefin (For example, refer to document 1.), and the like are known.

Meantime, concerning an information device that can read and write information within plural types of medium such as CD/DVD player, the optical pickup apparatus must have a structure that can correspond to shapes of the both mediums, difference in wavelength of light applied to the mediums, and the like. In such case, it is preferable that the optical unit can be used in common with either of the mediums, in terms of cost and pickup characteristic.

In addition, in recent years, as a medium that can record information with higher density compared to CD or DVD, medium such as Blu-ray Disc and the like, that records and reproducts information with a shorter wavelength compared to that of CD (λ=780 nm) or DVD (λ=635, 650 nm), and information device to read and write information with such medium, are developed. However, regarding what is called next-generation DVD such as Blu-ray Disc, in a case where light with short wavelength around 400 nm is used, it became obvious that dust or stain adhered to the optical element lens of the optical pickup part has a large influence on optical performance, compared to the cases where light for conventional DVD (λ=635, 650 nm) or CD (λ=780 nm) is used.

[document 1] Japanese Patent Application Publication No. 2002-105131, page 4.

Concerning information device of what is called next-generation DVD such as Blu-ray Disc, which uses light with short wavelength around 400 nm, stain due to the environment has a large negative influence on transmittance. Since a light with shorter wavelength is more influenced by light scattering due to dust or stain, the issue of decrease in transmittance becomes more prominent compared to conventional DVD (λ=635, 650 nm) or CD (λ=780 nm).

The present invention has been made to solve the above problem. An object of the invention is to suppress adherence of dust or stain due to the environment and provide an optical element that can maintain optical characteristic for a long period of time, and achieve high durability and reliability. It is also an object of the invention to provide an optical pickup apparatus with good pickup characteristic, using the optical element.

### SUMMARY OF THE INVENTION

According to various embodiments, the present teachings can provide an optical element comprising plastic compound. The optical element can be made by shaping the plastic compound. Charging characteristic of the optical element can be not less than +2 kV and not more than +15 kV. Transmission of the optical element for a light flux having a wavelength of 405 nm can be not less than 85%.

The above object can be achieved by the following structure.

A) An optical element, comprising: plastic compound, wherein the optical element is made by shaping the plastic compound, wherein charging characteristic of the optical element is not less than +2 kV and not more than +15 kV, and transmission of the optical element for a light flux having a wavelength of 405 nm is not less than 85%.

B) The optical element of A), wherein charging characteristic of the plastic compound is not less than +2 kV and not more than +15 kV, and transmission of the plastic compound for a light flux having a wavelength of 405 nm is not less than 85%.

C) The optical element of A), wherein the plastic compound comprises at least one kind of hindered amine stabilizer.

D) The optical element of A), wherein the plastic compound comprises at least one kind of antistatic agent.

E) The optical element of A), wherein the plastic compound comprises polymer A obtained from addition polymerization of α-olefin of which number of carbon atoms is 2 to 20 and cyclic olefin illustrated in a formula (1), or polymer B obtained from additional polymerization of α-olefin of which number of carbon atoms is 2 to 20 and cyclic olefin illustrated in a formula (2),

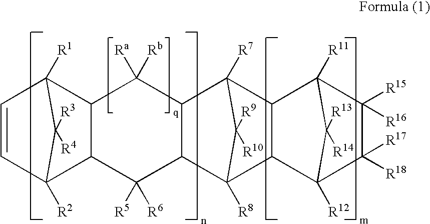

wherein in the formula (1), n represents 0 or 1, m represents 0 or integer which is not less than 1, q represents 0 or 1, R1-R18, Ra and Rb represent hydrogen atom, halogen atom or hydrocarbon group respectively and independently, R15-R18 can bind with each other to form monocycle or polycycle, the monocycle or the plycycle within the above parenthesis can comprise double bond, and R15 and R16 or R17 and R18 can form an alkylidene group,

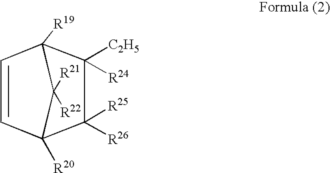

where in the formula (2), R19-R26 represent hydrogen atom, halogen atom or hydrocarbon group respectively and independently.

F) The optical element of E), wherein the polymer A or the polymer B comprises at least one kind of antistatic agent by 0.001 to 2.0 parts by weight for 100 parts by weight of the polymer.

G) The optical element of A), wherein the plastic compound comprises at least one type, or more than two types of stabilizer chosen among phenolic stabilizer, phosphorous stabilizer, and sulfur stabilizer.

H) The optical element of A), wherein the optical element comprises a layer comprising at least one kind of antistatic agent.

I) The optical element of D), wherein the antistatic agent is at least one of anion type antistatic agent, cation type antistatic agent, nonion type antistatic agent, ampholyte ion type antistatic agent, polymer antistatic agent, and conductive particle.

J) The optical element of I), wherein the average particle diameter of the conductive particle is not more than 100 nm.

K) The optical element of J), wherein the conductive particle is at least one type chosen among cerium oxide, indium oxide, tin oxide, antimony oxide, and silicone oxide.

L) The optical element of A), wherein melt index (MI) value of the plastic compound measured under conditions of 260 degrees Celsius and 2.16 kg load is in a range of

20<MI (g/10 min.)<60

and at least one of optical surface is provided with a predetermined fine structure.

M) The optical element of A), wherein the optical element is applied to an optical pickup apparatus capable of light condensing.

N) The optical element of A), wherein charging characteristic of the optical element is not less than +3 kv and not more than +10 kV.

O) An optical pickup apparatus to conduct at least either of reproducing or recording information within an optical information recording medium, comprising:

a light source to irradiate light; and

an optical unit to condense light from the light source on information recording surface of the optical information recording medium; wherein

the optical unit comprises at least one optical element; and

the optical element is made by shaping the plastic compound, charging characteristic of the optical element is not less than +2 kV and not more than +15 kV, and transmission of the optical element for a light flux having a wavelength of 405 nm is not less than 85%.

P) The optical pickup apparatus of 0), wherein the light source irradiates light with wavelength of 390-420 nm.

In addition, the object of the present invention can also be achieved by the following structure.

1) An optical element made by shaping the plastic compound, wherein charging characteristic of the plastic compound is not less than +2 kV and not more than +15 kV, and transmission of the optical element for a light flux having a wavelength of 400 nm is not less than 85%.

2) The optical element of 1), wherein the plastic compound comprises at least one kind of hindered amine stabilizer.

3) The optical element of 1) or 2), wherein the plastic compound comprises polymer A obtained from addition polymerization of α-olefin of which number of carbon atoms is 2 to 20 and cyclic olefin illustrated in a formula (1), or polymer B obtained from additional polymerization of α-olefin of which number of carbon atoms is 2 to 20 and cyclic olefin illustrated in a formula (2). 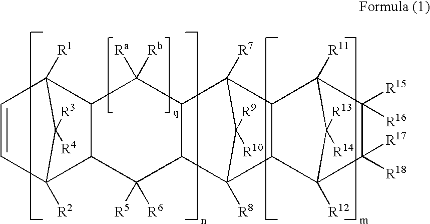
[wherein in the formula (1), n represents 0 or 1, m represents 0 or integer which is not less than 1, q represents 0 or 1, R1-R18, Ra and Rb represent hydrogen atom, halogen atom or hydrocarbon group respectively and independently, R15-R18 can bind with each other to form monocycle or polycycle, the monocycle or the plycycle within the above parenthesis can comprise double bond, and R15 and R16 or R17 and R18 can form an alkylidene group.] 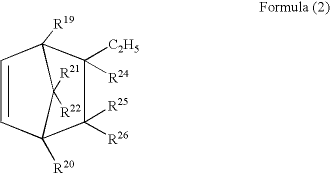
[where in the formula (2), R19-R26 represent hydrogen atom, halogen atom or hydrocarbon group respectively and independently.]

4) The optical element of 3), wherein the polymer A or the polymer B comprises at least one kind of antistatic agent by 0.001 to 2.0 parts by weight for 100 parts by weight of the polymer.

5) The optical element of any one of 1) through 4), wherein the plastic compound comprises at least one type, or more than two types of stabilizer chosen among phenolic stabilizer, phosphorous stabilizer, and sulfur stabilizer.

6) The optical element of any one of 1) through 5), provided with a layer comprising at least one kind of antistatic agent.

7) The optical element of 4) or 6), wherein the antistatic agent is at least one type chosen among anion type antistatic agent, cation type antistatic agent, nonion type antistatic agent, ampholyte ion type antistatic agent, polymer antistatic agent, and conductive particle.

8) The optical element of 7), wherein the average particle diameter of the conductive particle is not more than 100 nm.

9) The optical element of 7) or 8), wherein the conductive particle is at least one type chosen among cerium oxide, indium oxide, tin oxide, antimony oxide, and silicone oxide.

10) The optical element of any one of 1) through 9), wherein melt index (MI) value of the plastic compound measured under conditions of 260 degrees Celsius and 2.16 kg load is in a range of

20<MI (g/10 min.)<60

and at least one of optical surface is provided with a predetermined fine structure.

11) The optical element of any one of 1) through 10), applied to a light condensing apparatus capable of light condensing.

12) An optical pickup apparatus to conduct at least either of reproducing or recording information within an optical information recording medium, comprising: a light source to irradiate light; and an optical unit to conduct at least either of irradiating light from the light source to the optical information recording medium, or condensing light reflected from the light the optical information recording medium; wherein the optical unit comprises any one of optical element of 1) through 11).

13) The optical pickup apparatus of 12), wherein the light source irradiates light with wavelength of 390-420 nm.

According to the invention of the aforementioned A), B), and 1), since charging characteristic is low, adhesion of dust and stain can be suppressed in the environment of the optical element being arranged. Therefore, its optical characteristic can be maintained for a long period of time, and optical element with excellent durability and reliability can be obtained. As a result, a desirable optical element, concerning an optical information recording medium that have high information density using a light flux with short wavelength, such as Blu-ray Disc for example, can be obtained. Here, charging characteristic mentioned in the present invention indicates a friction-charged electrostatic potential as described later.

According to the optical element shaped by the plastic compound of the invention of 2), the optical element has high form stability, and even a in case where a light flux of high energy with wavelength around 400 nm is transmitted, white turbidity, change in refractive index, deformation of optical surface, and the like can be suppressed. Therefore, its optical characteristic can be maintained for a long period of time, and optical element with excellent durability and reliability can be obtained.

According to the invention of 3), since the plastic compound of the present invention applied to optical element includes hydrocarbon polymer with main chain that includes at least cycloaliphatic structure illustrated by formula (1) or formula (2), the optical element manufactured by using this plastic compound has high stability effect concerning irradiation of a light flux. For example, even a in case where a light flux with short wavelength of around 400 nm is continuously irradiated, white turbidity and change in refractive index is even further suppressed, and deformation of optical surface can also be suppressed. That is, light stability of the optical element can be improved, this characteristic can be maintained for a long period of time, and optical element with excellent durability and reliability can be obtained. In addition, since high Tg can be obtained, optical element with excellent heat stability can also be obtained.

Therefore, concerning an optical information recording medium with high information density such as Blu-ray Disc, reading and writing of information within excellent pickup characteristic can be conducted for a long period, thus an optical pickup apparatus with high reliability can be obtained.

According to the invention of 4), by adding to the plastic compound, a stabilizer arbitrary chosen among phenolic stabilizer, phosphorous stabilizer, and sulfur stabilizer, the change in optical characteristic concerning the shaped optical element can be further efficiently suppressed.

According to the invention of 5) or 6), it can be desirably used as an optical element, with remarkably high transmission around 400 nm, for optical information recording medium that have high information density, such as Blu-ray Disc. Further, by suppressing stain due to environment, an optical element with improved light stability around 400 nm can be obtained.

According to any one of inventions among 7) through 9), it can also be desirably used as an optical element, with remarkably high transmission around 400 nm, for optical information recording medium that have high information density, such as Blu-ray Disc. Further, by suppressing stain due to environment, an optical element with excellent durability and reliability, that have improved light stability around 400 nm, can be obtained.

According to the invention of 10), in addition to advantageous effects obtained by aforementioned 1) through 9), melt index (MI) value of the plastic compound measured under conditions of 260 degrees Celsius and 2.16 kg load is in a range of 20<MI (g/10 min.)<60, and at least one optical surface is provided with a predetermined fine structure. That is, since melt index is in a range that is suitable for shaping method such as injection molding and the like, molten plastic compound have desirable flowability. For example, in a case where an optical element is shaped by injection molding and the like, molten plastic compound can certainly reach the edge portions that correspond to a fine structure. Therefore, an optical element that was shaped as above is provided with the fine structure that is shaped with high degree of precision.

Further, since the optical element have high form stability, deformation of the fine structure can be suppressed adequately.

According to the invention of 11), in addition to advantageous effect obtained by aforementioned 1) through 11), since the optical element have high form stability even in a case where the optical element is applied to a light condensing apparatus capable of light condensing, decrease in optical characteristic of the optical element does not occur. That is, even in a case where high energy is applied to the optical element by light condensing, due to the high form stability of the optical element, deformation of the optical element can be suppressed for a long period of time, thus decrease in optical characteristic of the optical element can be prevented.

According to the invention of 12), by applying an optical element with improved light stability, durability, and reliability, a pickup apparatus with excellent durability and reliability can be obtained.

According to the invention of 13), concerning an optical information recording medium with high information density such as Blu-ray Disc, reading and writing of information within excellent pickup characteristic can be conducted for a long period, thus an optical pickup apparatus with high durability and reliability can be obtained.

### BREIF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a view showing a schematic structure of an optical pickup apparatus 1 according to the present invention;

FIG. 2 is a cross sectional view of objective lens 10 as an optical element according to the present invention;

FIG. 3 is a cross sectional view of objective lens 10a as an optical element according to the present invention;

FIG. 4 is a cross sectional view of objective lens 10b as an optical element according to the present invention;

FIG. 5 is a cross sectional view of objective lens 10c as an optical element according to the present invention;

FIG. 6 is a cross sectional view of objective lens 10d as an optical element according to the present invention;

FIG. 7 is a cross sectional view of hologram optical element 10e and objective lens 10f according to the present invention; and

FIG. 8 is result of conducting evaluation of fusion characteristic and optical characteristic, concerning the formed plates obtained by embodiment 1 through embodiment 9.

### DETAILED DESCRIPTION OF THE PREFERRED EMBODIMENT

An optical element of the present invention has charging characteristic that is not less than +2 kV and not more than +15 kV. Preferably, charging characteristic is not less than +3 kV and not more than +10 kV. In addition, concerning the optical element of the present invention, transmission of the optical element for a light flux having a wavelength of 405 nm is not less than 85%. Preferably, transmission of the optical element for a light flux having a wavelength of 400 nm is also not less than 85%.

Here, the charging characteristic of the optical element mentioned in the present specification is a friction-charged electrostatic potential measured by the following method.

Under an environment where temperature is 23 degrees Celsius and humidity is 40%, an optical element is attached to a surface of a rotating drum that has an outer diameter of approximately 150 mm and width of approximately 60 mm. Within the state of rotation at rotation speed of 400 rpm, the optical element is applied with a friction by a friction cloth that is pulled with load of 4.9N. The friction-charged electrostatic potential is measured after 60 seconds have elapsed from starting the application of friction. As for the friction cloth, a cloth comprising 60% of polyester and 40% of cotton is used.

Next, the transmission of the optical element mentioned in the present specification is a transmittance for a light flux having a wavelength of 405 nm, concerning a formed plate with a thickness of 3 mm obtained from a plastic compound, wherein the formed plate was made by the same conditions as forming the optical element from the plastic compound. The transmittance is measured by a spectrophotometer (preferably by HITACHI U4000). Here, in a case where it is difficult to obtain a formed plate with a thickness of 3 mm, transmittance of the optical element within 3 mm may be calculated according to the results obtained by measuring transmittance for a light flux having a wavelength of 405 nm by a spectrophotometer, concerning the optical element itself, and measuring the thickness of the optical element in the direction of optic axis.

In addition, it is preferable that the plastic compound applied to the optical element of the present invention has charging characteristic that is not less than +2 kV and not more than +15 kV (more preferably, not less than +3 kV and not more than +10 kV). Further, it is preferable that concerning the plastic compound applied to the optical element of the present invention, transmission for a light flux having a wavelength of 405 nm is not less than 85%.

Here, the charging characteristic of the plastic compound mentioned in the present specification is a friction-charged electrostatic potential measured by the following method.

Under an environment where temperature is 23 degrees Celsius and humidity is 40%, a plastic compound that is formed into a plastic plate of 10 cm×10 cm×3 cm, is attached to a surface of a rotating drum that has an outer diameter of approximately 150 mm and width of approximately 60 mm. Within the state of rotation at rotation speed of 400 rpm, the optical element is applied with a friction by a friction cloth that is pulled with load of 4.9N. The friction-charged electrostatic potential is measured after 60 seconds has elapsed from starting the application of friction. As for the friction cloth, a cloth comprising 60% of polyester and 40% of cotton is used.

The transmission of the plastic compound mentioned in the present specification is measured in the same manner as the aforementioned transmission of the optical element.

The plastic compound applied to the optical element of the present invention preferably comprises polymer A or polymer B. Here, polymer A is a polymer obtained from addition polymerization of α-olefin of which number of carbon atom is 2 to 20 and a monomer composition comprised of cyclic olefin illustrated in a formula (1), and polymer B is a polymer obtained from addition polymerization of at least α-olefin of which number of carbon atom is 2 to 20 and a monomer composition comprised of cyclic olefin illustrated in a formula (2).

Description on the polymer A used in the present invention is given hereinafter.

The polymer A used in the present invention is a copolymer of α-olefin and cyclic olefin obtained from copolymerization of α-olefin of which number of carbon atom is 2 to 20 and the cyclic olefin illustrated in the formula (1).

The α-olefin used for copolymerization may be linear or branched, linear α-olefin of which number of carbon atom is 2 to 20 such as ethylene, propylene, buta-1-ene, penta-1-ene, hexa-1-ene, octa-1-ene, deca-1-ene, dodeca-1-ene, tetradeca-1-ene, hexadeca-1-ene, octadeca-1-ene, eicosa-1-ene, and the like; and branched α-olefin of which number of carbon atom is 4 to 20 such as 3-methyl buta-1-ene, 3-methyl penta-1-ene, 3-ethyl penta-1-ene, 4-methyl penta-1-ene, 4-methyl hexa-1-ene, 4,4-dimethyl hexa-1-ene, 4,4-dimethyl penta-1-ene, 4-ethyl hexa-1-ene, 3-ethyl hexa-1-ene, and the like can be mentioned. Among these, linear α-olefin of which number of carbon atom is 2 to 4 is preferable, and ethylene is the most preferable. These linear and branched α-olefins can be used alone or in combination of two types or more.

Description on the cyclic olefin (1) used in the copolymerization is given hereinafter.

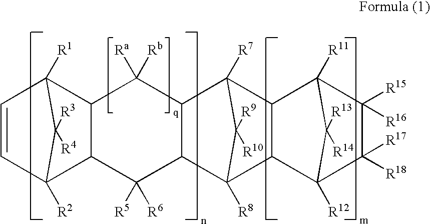

In the above formula (1), n represents 0 or 1, m represents 0 or integer which is not less than 1, wherein n and m are not 0 at the same time, and q represents 0 or 1. Here, when q is 1, R^{a} and R^{b} represent atom or hydrocarbon group described below respectively and independently, and when q is 0, bond between R^{a} and R^{b} does not exist, and carbon atom at both ends form a bond so as to form a 5-membered ring.

R¹-R¹⁸, R^{a}, and R^{b} represent hydrogen atom, halogen atom, or hydrocarbon group respectively and independently. Here, the halogen atom is fluorine atom, chlorine atom, bromine atom, or iodine atom.

In addition, as the hydrocarbon group, alkyl group of which number of carbon atom is 1 to 20, cycloalkyl group of which number of carbon atom is 3 to 15, or aromatic hydrocarbon group can be mentioned respectively and independently. Specifically, examples of the alkyl group include methyl group, ethyl group, propyl group, isopropyl group, amyl group, hexyl group, octyl group, decyl group, dodecyl group, and octadecyl group. An example of the cycloalkyl group is cyclohexyl group, and examples of aromatic hydrocarbon group include phenyl group and naphtyl group. The hydrogen atom of these hydrocarbon groups may be substituted with halogen atom.

Specific examples of the cyclic olefin illustrated in the formula (1) are given hereinafter. As for example, bicyclo[2.2.1]hept-2-ene derivatives such as cyclopentadiene acenaphtylene adducts, 1,4-metano-1,4,4a,9a-tetrahydrofluorene, and 1,4-metano-1,4,4a,5,10,10a-hexahydroanthracene can be mentioned.

Further, tricyclo[4.3.0.1^{2,5}]deca-3-ene derivatives such as tricyclo[4.3.0.1^{2,5}]deca-3-ene, 2-methyl tricyclo[4.3.0.1^{2,5}]deca-3-ene, 5-methyl tricyclo[4.3.0.1^{2,5}]deca-3-ene; tricyclo[4.4.0.1^{2,5}]undeca-3-ene derivatives such as tricyclo[4.4.0.1^{2,5}]undeca-3-ene, and 10-methyl tricyclo[4.4.0.1^{2,5}]undeca-3-ene; tetracyclo[4.4.0.1^{2,5}.1^{7,10}]dodeca-3-ene illustrated in a formula (3) (Hereinafter referred to as “tetracyclododecene”, and numerals of 1-12 indicate position number of carbon atoms.); and derivatives of such by substitution with hydrocarbon groups can be mentioned.

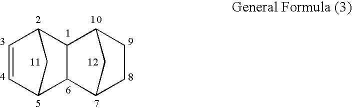

As for the hydrocarbon group of the substituting group, 8-methyl, 8-ethyl, 8-propyl, 8-butyl, 8-isobutyl, 8-hexyl, 8-cyclohexyl, 8-stearyl, 5,10-dimethyl, 2,10-dimethyl, 8,9-dimethyl, 8-ethyl-9-methyl, 11,12-dimethyl, 2,7,9-trimethyl, 2,7-dimethyl-9-ethyl, 9-isobutyl-2,7-dimethyl, 9,11,12-trimethyl, 9-ethyl-11,12-dimethyl, 9-isobutyl-11,12-dimethyl, 5,8,9,10-tetramethyl, 8-ethylidene, 8-ethylidene-9-methyl, 8-ethylidene-9-ethyl, 8-ethylidene-9-isopropyl, 8-ethylidene-9-butyl, 8-n-propylidene, 8-n-propylidene-9-methyl, 8-n-propylidene-9-ethyl, 8-n-propylidene-9-isopropyl, 8-n-propylidene-9-butyl, 8-isopropylidene, 8-isopropylidene-9-methyl, 8-isopropylidene-9-ethyl, 8-isopropylidene-9-isopropyl, 8-isopropylidene-9-butyl, 8-chloro, 8-bromo, 8-fluoro, 8,9-dichloro, 8-phenyl, 8-methyl-8-phenyl, 8-benzyl, 8-tolyl, 8-(ethylphenyl), 8-(isopropylphenyl), 8,9-diphenyl, 8-(biphenyl), 8-(β-naphtyl), 8-(α-naphtyl), 8-(antracenyl), 5,6-diphenyl, and the like can be mentioned.

Next, description on the polymer B used in the present invention is described.

The polymer B used in the present invention is a copolymer of α-olefin and cyclic olefin obtained by copolymerization of α-olefin of which number of carbon atom is 2 to 20 and cyclic olefin illustrated in the formula (2).

The α-olefin used for copolymerization is the same with the one used in manufacturing the polymer A. Description on the cyclic olefin illustrated in the below formula (2) used in the copolymerization is given hereinafter.

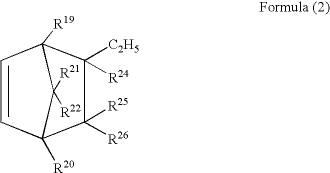

In the above formula (2), R¹⁹-R²⁶ represent hydrogen atom, halogen atom, or hydrocarbon group respectively and independently. The halogen atom is fluorine atom, chlorine atom, bromine atom, or iodine atom. In addition, as the hydrocarbon group, alkyl group of which number of carbon atom is 1 to 20, cycloalkyl group of which number of carbon atom is 3 to 15, or aromatic hydrocarbon group can be mentioned respectively and independently. Specifically, examples of the alkyl group include methyl group, ethyl group, propyl group, isopropyl group, amyl group, hexyl group, octyl group, decyl group, dodecyl group, and octadecyl group. An example of the cycloalkyl group is cyclohexyl group, and examples of aromatic hydrocarbon group include phenyl group and naphtyl group. The hydrogen atom of these hydrocarbon groups may be substituted with halogen atom.

Examples of the cyclic olefin illustrated in the above formula (2) will be given specifically hereinafter.

As for an example, bicyclo[2.2.1]hepta-2-ene (otherwise known as norbornene, wherein the numerals of 1-7 indicate position number of carbon atom) illustrated in a below formula (4), and its derivatives obtained by substitution with hydrocarbon groups can be mentioned.

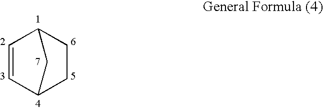

As for the hydrocarbon group for substitution, 5-methyl, 5,6-dimethyl, 1-methyl, 5-ethyl, 5-n-butyl, 5-isobutyl, 7-methyl, 5-phenyl, 5-methyl-5-phenyl, 5-benzyl, 5-tolyl, 5-(ethylphenyl), 5-(isopropylphenyl), 5-(biphenyl), 5-(β-naphtyl), 5-(α-naphtyl), 5-(antracenyl), 5,6-diphenyl, and the like can be mentioned.

The copolymerization reaction of the α-olefin and the cyclic olefin is conducted in hydrocarbon solvent. A manufacturing method which uses a catalyst obtained from vanadium compound and organic aluminum compound, that is soluble in the hydrocarbon solvent, is preferable. In addition, solid metallocene catalysts of elements in the VI group of the periodic table can be used in this copolymerization reaction. Here, the solid metallocene catalyst of elements in the VI group of the periodic table is a catalyst comprising a transition metal compound with a ligand of cyclopentadienyl structure, an organic aluminum oxy compound, and an organic aluminum compound which is added within need. Here, as a transition metal in the VI group of the periodic table, zirconium, titanium, and hafnium can be mentioned, and it is a catalyst wherein these transition metals have at least one ligand including cyclopentadienyl structure. As for an example of a ligand including cyclopentadienyl structure, a cyclopentadienyl group, an indenyl group, a tetrahydroindenyl group, a fluorenyl group, and the like can be mentioned. Here, cyclopentadienyl group may be a substituted by alkyl group. These groups may be bonded through other groups such as alkylene group. In addition, as for an example of a ligand other than those including cyclopentadienyl structure, alkyl group, cycloalkyl group, aryl group, aralkyl group, and the like can be mentioned. As for the organic aluminum oxy compound and the organic aluminum compound, ones that are usually used in manufacturing polyolefin can be used.

Concerning the copolymer of α-olefin of which number of carbon atom is 2 to 20 and cyclic olefin, constitutional unit derived from α-olefin is usually 5-95 mole %, more preferably 20-80 mole %; and constitutional unit derived from cyclic olefin is usually 5-95 mole %, more preferably 20-80 mole %. Here, the composition ratio of α-olefin and cyclic olefin is measured by ¹³C-NMR.

As for the polymerization reaction, radical polymerization, anion polymerization, and cation polymerization can be used, and is not limited to these.

In a case where radical polymerization is conducted, under the presence of initiator, the reaction is usually performed at 0 to 200 degrees Celsius, more preferably at 20 to 150 degrees Celsius. The reaction can be performed by mass polymerization, solution polymerization, suspension polymerization, emulsion polymerization, and the like, however in case where it is needed to prevent incorporation of impurities into the plastic, mass polymerization and suspension polymerization is preferable. As for radical initiator, peroxides such as benzoyl peroxide, lauroyl peroxide, t-butyl-peroxy-2-ethylhexanoate, and the like; azo compounds such as azoisobutyronitrile, 4,4-azobis-4-cyanopentanoic acid, azodibenzoyl, and the like; water soluble catalysts such as potassium persulfate, ammonium persulfate, and the like; and redox initiator can be used.

In a case where anion polymerization is conducted, under the presence of initiator, the reaction is usually performed at 0 to 200 degrees Celsius, more preferably at 20 to 100 degrees Celsius, and further preferably at 20 to 80 degrees Celsius. The reaction can be performed by mass polymerization, solution polymerization, slurry polymerization, and the like, however, concerning removal of reaction heat, solution polymerization is preferable. In this case, inert solvent that can dissolve polymer and its hydride is preferable. As for examples of inert solvent used in solution polymerization, aliphatic hydrocarbons such as n-butane, n-pentane, iso-pentane, n-hexane, n-heptane, iso-octane, and the like; cycloaliphatic hydrocarbons such as cyclopentane, cyclohexane, methylcyclopentane, methylcyclohexane, decaline, and the like; and aromatic hydrocarbons such as benzene, toluene, and the like; can be mentioned. Among them, in a case where aliphatic hydrocarbons or cycloaliphatic hydrocarbons are used, it can be used in situ as an inert solvent concerning hydrolysis reaction. These solvents can be used alone or in combination of two or more types of solvents, and is usually used by amount of 200 to 10,000 parts by weight, for 100 parts by weight of the entire monomer.

As for an initiator of the above anion polymerization, for example, mono organic lithium such as n-butyllithium, sec-butyllithium, t-butyllithium, hexyllithium, phenyllithium, and the like; and multi functional organic lithium compounds such as dilithiomethane, 1,4-dilithiobutane, 1,4-dilithio-2-ethylcyclohexane, and the like; can be used.

The polymer obtained by the above mentioned radical polymerization and anion polymerization can be collected through conventional methods such as steam stripping method, direct desolvation method, alcohol coagulation method, and the like.

Concerning the polymer of the present invention, it is preferable that the glass transition temperature (Tg) measured by DSC (rate of temperature increase 10° C./min) is 60 to 230 degrees Celsius, and more preferably 70 to 210 degrees Celsius.

As for the softening point measured by thermo chemical analyzer (TMA), it is usually 30 degrees Celsius or higher, preferably 70 degrees Celsius or higher, more preferably 80 degrees Celsius or higher, further preferably 90 to 250 degrees Celsius, and particularly preferable that it is 100 to 200 degrees Celsius. Here, softening point was measured using Thermo Mechanical Analyzer of DuPont, concerning thermal deformation behavior of a sheet with 1 mm thickness. That is, under the conditions that the rate of temperature increase is 5° C./min, the temperature at when a quartz needle placed on the sheet, with a load of 49 g, penetrates into the sheet by 0.635 mm was measured as softening point (TMA).

It is preferable that the plastic compound of the present invention comprises polymer represented as polymer A or polymer represented as polymer B. An optical element manufactured by using this plastic compound is prevented from degradation of the element such as white turbidity, change in transmittance, and deformation of optical surface; even in a case where a light flux having a wavelength in the range of 390 nm to 420 nm that corresponds to optical information recording medium that have high information density such as Blu-ray Disc, is transmitted through the optical element, in particular.

In addition, it is preferable that the plastic compound of the present invention includes hindered amine stabilizer. Description on hindered amine stabilizer applied to the plastic compound of the present invention is given hereinafter. By choosing these stabilizer arbitrarily and adding it to the polymer of the present invention, stain due to environment can be suppressed, as well as white turbidity and change in optical characteristic such as change in refractive index in case of continuous irradiation of light with shore wavelength of 400 nm can be highly suppressed. The amount of the hindered amine type stabilizer added is 0.05 to 2 parts by weight, more preferably 0.1 to 1 parts by weight, for 100 parts by weight of the polymer including cycloaliphatic structure.

Here, as for preferable hindered amine stabilizer, bis (2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butylmalonate, bis(1-acroyl-2,2,6,6-tetramethyl-4-piperidyl) 2,2-bis(3,5-di-t-butyl-4-hydroxybenzyl)-2-butylmalonate, bis(1,2,2,6,6-pentamethyl-4-piperidyldecane)dioate, 2,2,6,6-tetramethyl-4-piperidylmethacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propionamide, tetraxis (2,2,6,6-tetramethyl-4-piperidy) 1,2,3,4-butanetetracarboxylate, tetraxis (1,2,2,6,6-pentamethyl-4-piperidyl) 1,2,3,4-butanetetracarboxylate, and the like can be mentioned.

(Antistatic Agent)

Concerning the plastic material of the present invention, it is preferable that the plastic material comprises antistatic agent, wherein at least one kind of antistatic agent is contained 0.001 to 2.0 parts by weight for 100 parts by weight of the polymer including cycloaliphatic structure.

As for antistatic agent that can be used for the plastic material of the present invention, there is no particular limitation, and conventional antistatic agent can be used. Among them, it is preferable that antistatic agent is chose from at least one kind among anion type antistatic agent, cation type antistatic agent, nonion type antistatic agent, ampholyte ion type antistatic agent, polymer antistatic agent, and conductive particle. It is further preferable that it is conductive particle, and particularly preferable that it is at least one kind chosen among cerium oxide, indium oxide, tin oxide, antimony oxide, and silicone oxide.

Description on antistatic agent that can be applied to the plastic material of the present invention is given hereinafter.

As for anion type antistatic agent, for example, aliphatic acid salts, fatty alcohol sulfates, liquid fatty oil sulfates, sulfates of aliphatic amine and aliphatic amide, aliphatic alcohol phosphates, sulfonates of dibasic fatty ester, aliphatic amide sulfonates, alkyl allyl sulfonates, naphtalene-sulphonic acid/formaldehyde condensation product, and the like can be mentioned. As for cation type antistatic agent, for example, aliphatic amine salts, tertialy ammonium salts, alkyl pyridinium salts, and the like can be mentioned. As for nonion type antistatic agent, for example, polyoxyethylene alkyl ethers, polyoxyethylene alkylphenol ethers, polyoxyethylene alkyl esters, sorbitan alkyl esters, polyoxyethylene sorbitan alkyl esters, and the like can be mentioned. As for ampholyte ion type antistatic agent, for example, imidazoline derivatives, betaine-type higher alkyl amino derivatives, sulfate ester derivatives, phosphate ester derivatives, and the like can be mentioned. Specific compounds are disclosed in “Antistatic Agent Surface Reforming of Polymers”, written by Hideo Marushige, published from Saiwai-Shobo, enlarged edition “Handbook of Practical Additives for Plastics and Rubber”, pages 333 through 455, published from The Chemical Daily Co., Ltd., Japanese Patent Application Laid-Open No. 11-256143, Japanese Patent No. 52-32572, Japanese Patent Application Laid-Open No. 10-158484, and the like.

As for preferable antistatic agent, ionic polymer compounds such as anion type antistatic agent and cation type antistatic agent can be mentioned. As for ionic polymer compounds, anion type polymer compounds such as those disclosed in Japanese Patent No. 49-23828, Japanese Patent No. 49-23827, and Japanese Patent No. 47-28937; ionene type polymers that have dissociation group in their main chain, such as those disclosed in Japanese Patent No. 55-734, Japanese Patent No. 50-54672, Japanese Patent No. 59-14735, Japanese Patent No. 57-18175, Japanese Patent No. 57-18176, Japanese Patent No. 57-56059, and the like; cation type pendant polymers that have cationic dissociation group in their main chain, such as those disclosed in Japanese Patent No. 53-13223, Japanese Patent No. 57-15376, Japanese Patent No. 53-45231, Japanese Patent No. 55-145783, Japanese Patent No. 55-65950, Japanese Patent No. 55-67746, Japanese Patent No. 57-11342, Japanese Patent No. 57-19735, Japanese Patent No. 58-56858, Japanese Patent Application Laid-Open No. 61-27853, Japanese Patent Application Laid-Open No. 62-9346, and the like; and graft copolymer such as those disclosed in Japanese Patent Application Laid-Open No. 5-230161, and the like can be mentioned.

In addition, as for conductive particles that can be used particularly preferably in the present invention, concerning examples of metal oxides, ZnO, TiO₂, SnO₂, Al₂O₃, In₂O₃, SiO₂, MgO, BaO, CeO₂, Sb₂O₃, MoO₂, V₂O₅, and the like, or compound oxides of these are preferable, and particularly, CeO₂, In₂O₃, SnO₂, Sb₂O₃, and SiO₂ is preferable. As for an example comprising heterogeneous atoms, addition of Al, In, and the like to ZnO; addition of Nb, Ta, and the like to TiO₂; and addition of Sb, Nb, halogen atoms, and the like to SnO₂, are effective. The amount of heterogeneous atoms added is preferably in the range of 0.01 mol % to 25 mol %, and more preferably in the range of 0.1 mol % to 15 mol %.

In the present invention, the average particle diameter of the conductive particle is preferably not more than 100 nm, and more preferably 5 to 100 nm. It is preferable that the average particle diameter of the conductive particle is not more than 100 nm, concerning addition to the plastic material, since effective charging characteristic can be provided to the plastic material, and also maintain transparency of the plastic material.

Antistatic agent that is particularly preferable is, concerning the relation between antistatic property and amount of addition, the one with surface resistivity value of 1×10¹⁰Ω or less. The surface resistivity value is measured in accordance with ASTM D257, after humidity conditioning the test sample under atmosphere of 23 degrees Celsius and 50% RH for 24 hours, using an ultra insulation measuring instrument.

In addition, antistatic agent that can be preferably used in the present invention is ionene conductive polymer or tertial ammonium cationic conductive polymer with intermolecular bridge structure, such as those disclosed in Japanese Patent Application Laid-Open No. 9-203810.

Characteristic of the tertial ammonium cationic conductive polymer is within the obtained dispersive particle polymer, and since it is capable of keeping the cationic component in the particle at high concentration and high density, it not only has superior conductive property, but also has good compatibility with the plastic and high transparency, and the conductivity does not degrade under low relative humidity.

The dispersive particle polymer of bridged type cationic conductive polymer used to prevent static electricity generally has particle size ranging in approximately 0.01 μm to 0.3 μm, and preferably has particle size ranging in 0.05 μm to 0.15 μm.

In the present invention, each of the aforementioned antistatic agents is added preferably in the range of 0.001 to 2.0 parts by weight for 100 parts by weight of polymer including cycloaliphatic structure. When the amount of antistatic agent added is not less than 0.001 parts by weight and not more than 2.0 parts by weight, it can efficiently prevent adhesion of dust or stain to the plastic material, thus maintain light transmittance of the plastic material at predetermined value. Here, the amount of antistatic agent added is preferably 0.005 to 1.0 parts by weight for 100 parts by weight of polymer including cycloaliphatic structure, and more preferably 0.01 to 0.5 parts by weight.

In the present invention, similar effect can be obtained by providing a layer that contains the above mentioned antistatic agent or fluorine compound conventionally used for antifouling, to the plastic.

In addition, in order to obtain the performance of the optical element of the present invention, a layer comprising at least one kind of antistatic agent (antistatic layer) may be provided on the surface of the optical element.

The antistatic layer may be provided by coating a mixture comprising the aforementioned antistatic agent on the surface of the optical element, or may be provided by method such as vapor deposition or the like. Here, the thickness of the antistatic layer is preferably not less than 50 μm and not more than 300 μm.

(Other Stabilizers)

In the plastic compound of the present invention, at least one kind of stabilizer chosen among phenolic stabilizers, phosphorous stabilizers, and sulfur stabilizers, may be added. By choosing these stabilizer arbitrarily and adding it to the polymer of the present invention white turbidity in a case where continuous irradiation of light flux with short wavelength of 400 nm is applied, and change in optical characteristic such as change in refractive index can be highly suppressed.

As for preferable phenolic stabilizer, conventional ones can be used, for example, acrylate compounds that are disclosed in Japanese Patent Application Laid-Open No. 63-179953 and Japanese Patent Application Laid-Open No. 1-168643 such as 2-t-butyl-6-(3-t-butyl-2-hydroxy-5-methylbenxyl)-4-methylphenylacrylate, 2,4-di-t-amyl-6-(1-(3,5-di-t-amyl-2-hydroxyphenyl)ethyl)phenylacrylate, and the like; alkyl substituted phenolic compounds such as octadecyl-3-(3,5-di-t-butyl-4-hydroxyphenyl)propionate, 2,2′-methylene-bis(4-methyl-6-t-butylphenol), 1,1,3-tris (2-methyl-4-hydroxy-5-t-butylphenyl)butane, 1,3,5-trimethyl-2,4,6-tris(3,5-di-t-butyl-4-hydroxybenzyl)benzene, tetraxis (methylene-3-(3′,5′-di-t-butyl-4′-hydroxyphenylpropionate))methane [what is called pentaerylthrimethyl-tetraxis (3-(3,5-di-t-butyl-4-hydroxyphenylpropionate))], triethylene glycol bis(3-(3-t-butyl-4-hydroxy-5-methylphenyl)propionate), and the like; and phenolic compounds containing triazine group such as 6-(4-hydroxy-3,5-di-t-butylanilino)-2,4-bis octylthio-1,3,5-triazine, 4-bis octylthio-1,3,5-triazine, 2-octylthio-4,6-bis-(3,5-di-t-butyl-4-oxyanilino)-1,3,5-triazine, and the like; can be mentioned.

In addition, as for preferable phosphorous stabilizer, there is no specific limitation as long as it is usually used in general plastic industry, for example, mono-phosphite compounds such as triphenyl phosphite, diphenylisodecyl phosphite, phenyldiisodecyl phosphite, tris(nonylphenyl)phosphite, tris(dinonylphenyl)phosphite, tris(2,4-di-t-butylphenyl)phosphite, 10-(3,5-di-t-butyl-4-hydroxybenzyl)-9,10-dihydro-9-oxa-10-phospha phenanthrene-10-oxide, and the like; di-phosphite compounds such as 4,4′-butylidene-bis(3-methyl-6-t-butylphenyl-di-tridecylphosphite), 4,4′-isopropylidene-bis-(phenyl-di-alkyl (C12 to C15)phosphite), and the like; can be mentioned. Among these, mono-phosphite compounds are preferable, and tris(nonylphenyl)phosphite, tris (dinonylphenyl)phosphite, and tris(2,4-di-t-butylphenyl)phosphite are particularly preferable.

In addition, as for preferable sulfur stabilizer, for example, dilauryl-3,3-thiodipropionate, dimyristyl-3,3′-thiodipropionate, distearyl 3,3-thiodipropionate, lauryl stearyl 3,3-thiodipropionate, pentaerythritol-tetraxis-(β-lauryl-thio-propionate), 3,9-bis(2-dodecylthioethyl)-2,4,8,10-tetraoxa spiro[5,5]undecane, and the like can be mentioned.

The blending quantity of these stabilizers can be arbitrarily selected as long as it does not deviate the object of the present invention, however, 0.01 to 2 parts by weight for 100 parts by weight of polymer of the present invention is added, and more preferably 0.01 to 1 parts by weight.

(Surfactant)

Surfactant is a compound that includes a hydrophilic group and a hydrophobic group in one molecule. Surfactant prevents white turbidity by adjusting the speed of moisture adhesion to the surface of the plastic and the speed of moisture evaporation from the surface of the plastic.

As for the hydrophilic group of the surfactant, specifically, hydroxyl group, hydroxyalkyl group with one or more carbon atoms, carbonyl group, ester group, amino group, amide group, ammonium salt, thiol, sulfate, phosphate, polyalkyleneglycol group, and the like can be mentioned. Here, amino group can be any of primary, secondary, or tertiary amine. As for hydrophobic group of the surfactant, specifically, alkyl group with six or more carbon atoms, silyl group including alkyl group with six or more carbon atoms, fluoroalkyl group with six or more carbon atoms, and the like can be mentioned. Here, the alkyl group with six or more carbon atoms may have aromatic ring as a substituting group. As for alkyl group, specifically, hexyl, heptyl, octyl, nonyl, decyl, undecenyl, dodecyl, tridecyl, tetradecyl, myristyl, stearyl, lauryl, palmityl, cyclohexyl, and the like can be mentioned. As for aromatic ring, phenyl group can be mentioned. This surfactant includes at least one of each hydrophilic group and hydrophobic group as mentioned above, or may include two or more of each group.

As for these surfactants, more specifically for example, myristyl diethanolamine, 2-hydroxyethyl-2-hydroxyldodexylamine, 2-hydroxyehtyl-2-hydroxytridecylamine, 2-hydroxyehtyl-2-hydroxytetradecylamine, pentaerythritolmonostearate, pentaerythritoldistearate, pentaerythritoltristearate, di-2-hydroxyethyl-2-hydroxydodecylamine, alkyl (number of carbon atom is 8 to 18)benzyldimethylammonium chloride, ethylene bis alkyl (number of carbon atom is 8 to 18)amide, stearyl diethanolamide, lauryl diethanolamide, myristyl diethanolamide, palmityl diethanolamide, and the like can be mentioned. Among these, amine compounds and amide compounds with hydroxyalkyl group are used preferably. In the present invention, two or more kinds of these compounds may be combined and used.

The surfactant is added within 0.01 to 10 parts by weight for 100 parts by weight of polymer of the present invention. When the added amount of the surfactant is not less than 0.01 parts by weight, white turbidity of the molded product due to change in temperature and humidity can be suppressed efficiently. Meantime, when the added amount of the surfactant is not more than 10 parts by weight, the light transmittance of the molded product does not become too low, thus application to optical pickup apparatus becomes easy. The added amount of the surfactant is preferably 0.05 to 5 parts by weight for 100 parts by weight of polymer of the present invention, and more preferably 0.3 to 3 parts by weight.

(Plasticizer)

Plasticizer is added as in need to adjust melt index of the cyclic olefin plastic.

As for plasticizer, known plasticizers such as bis(2-ethylhexyl)adipate, bis(2-budoxyehtyl)adipate, bis(2-ethylhexyl)azelate, dipropyleneglycol dibenzoate, tri-n-butyl citrate, tri-n-butylacetyl citrate, epoxidized soybean oil, 2-ethylhexyl epoxidized tall oil, chlorinated paraffin, tri-2-ethylhexyl phosphate, tricresyl phosphate, t-butylphenyl phosphate, tri-2-ethylhexyldiphenyl phosphate, dibutyl phtalate, diisohexyl phthalate, diheptyl phthalate, dinonyl phthalate, diundecyl phthalate, di-2-ethylhexyl phthalate, diisononyl phthalate, diisodecyl phthalate, ditridecyl phthalate, butylbenzyl phthalate, disyclohexyl phthalate, bis(2-ethylhexyl)sebacate, (tri-2-ethylhexyl)trimellitic acid, Santicizer 278, Paraplex G40, Drapex 334F, Plastolein 9720, Mesamoll, DNODP-610, HB-40, and the like can be used. Selection of placticizer and its amount of addition can be determined arbitrarily so long as transmittance and durability against change in the environment of the cyclic olefin are not degraded.

These cyclic olefin type plastic have excellent properties of transparency, low birefringence, heat resistance, heat aging resistance, chemical resistance, solvent resistance, dielectric property, various kinds of mechanical characteristic, high-precision molding property, and dampproof property (low water-absorbing property). In particular, the cyclic olefin type plastic of the present invention includes structure unit derived from highly hindered cyclic olefin, and surfactant provided with hydrophilic group and hydrophobic group in the same molecule, at a predetermined rate. Therefore, it can maintain excellent transparency even in a case where the environment changes form high temperature and high humidity, to ambient temperature and ambient humidity.

In the present invention, plastic compound that have plastic including the above mentioned polymer, blended with other plastic, can be added where appropriate. The other plastic is added in a range so as not to deviate the object of the present invention.

Here, examples of the other plastic that can be added to the polymer plastic compound of the present invention are described.

(1) A polymer derived from hydrocarbon including one or two unsaturated bond, for example, polyolefin such as polyethylene, polypropylene, polymethylbuta-1-ene, poly-4-methylpenta-1-ene, polybuta-1-ene, polystyrene, and the like can be mentioned. Here, these polyolefin may include bridged structure.

(2) Halogen containing vinyl polymer, such as polyvinyl chloride, polyvinylidene chloride, polyvinyl fluoride, polychloroprene, chlorinated rubber, and the like can be mentioned.

(3) Polymer derived from α,β-unsaturated acid and its derivatives, such as polyacrylate, polymethacrylate, polyacrylamide, polyacrylonitrile; or copolymer with monomer that structure the aforementioned polymer such as acrylonitirle butadiene styrene copolymer, acrylonitirle styrene copolymer, acrylonitrile styrene acrylic acid ester copolymer, and the like; can be mentioned.

(4) Polymer derived from unsaturated alcohol and amine, acylated derivatives of unsaturated alcohol, and derivatives of acetal, such as polyvinylalcohol, polyvinylacetate, polyvinylstearate, polyvinylbenzoate, polyvinylmaleate, polyvinylbutyral, polyallylphthalate, polyallylmeramine; or copolymer with monomer that structure the aforementioned polymer such as ethylene vinylacetate copolymer, and the like; can be mentioned.

(5) Polymer derived from epoxide, such as polyoxymethyleneoxide, or polymer derived from bis glycidyl ether can be mentioned.

(6) A class of polyacetals such as polyoxymethylene, polyoxyethylene, polyoxymethylene that include ethylene oxide as comonomer, and the like, can be mentioned.

(7) Polyphenylene oxide, (8) polycarbonate, (9) S polysulfone, (10) polyurethane and urea resin, can be mentioned.

(11) Polyamide or copolyamide derived from diamine and dicarboxylic acid and/or amino carboxylic acid, or corresponding lactam, such as nylon 6, nylon 66, nylon 11, nylon 12, and the like, can be mentioned.

(12) Polyester derived from dicarboxylic acid and dialcohol and/or oxycaroxylic acid, or corresponding lactone, such as polyethylene terephthalate, polybutylene terephthalate, poly 1,4-dimethylol cyclohexane terephthalate, and the like, can be mentioned.

(13) Polymer having bridged structure, derived from aldehyde and phenol, urea or meramine, such as phenol formaldehyde resin, urea formaldehyde resin, meramine formaldehyde resin, and the like, can be mentioned.

(14) Alkyd resin, such as glycerin phthalic acid resin and the like can be mentioned.

(15) Unsaturated polyester resin and halogen containing modified resin, obtained from copolyester of saturated and unsaturated dicarboxylic acid with polyol that is crosslinked by vinyl compound, can be mentioned.

(16) Natural polymer such as cellulose, rubber, protein, derivatives of those such as cellulose acetate, cellulose propionate, cellulose ether, and the like, can be mentioned.

(17) Soft polymer such as soft polymer containing cyclic olefin component, α-olefin type copolymer, α-olefin•diene type copolymer, aromatic vinyl type hydrocarbon•conjugated diene type soft copolymer, soft polymer or copolymer including isobutylene or isobutylene•conjugated diene, and the like, can be mentioned.

(18) Hydrocarbon polymer with side chain that includes cycloaliphatic structure.

As for method of blending the polymer of the present invention with the other plastic component, additives, or the like, known methods can be applied, such as blending each component at the same time.

The plastic compound of the present invention prepared as aforementioned preferably has melt index (MI) of 20 to 60 g/10 min. Here, the mentioned MI is amount of plastic that flows in ten minutes concerning an extrusion plastometer with nozzle of 1 mm inner diameter, under conditions of 260 degrees Celsius and load of 2.16 kg.

Here, the above mentioned MI can be adjusted by known methods such as controlling crystallization degree by selection of monomer ratio, controlling molecular weight by selection of polymerization method and polymerization condition, addition of plasticizer, and the like.

By maintaining the MI of the cyclic olefin plastic in the aforementioned range, when molding the optical element by methods such as injection molding, the molten plastic compound of the present invention can reach the edge of portions corresponding to metal molds of orbicular lens surface, orbicular zone plate, salient portion of orbicular zone, concave portion of orbicular zone, as described later. Therefore, the above mentioned portions can be formed with high degree of precision. As a result, optical element that can irradiate light to medium and collect reflected light with high accuracy can be manufactured.

(Optical Pickup Apparatus)

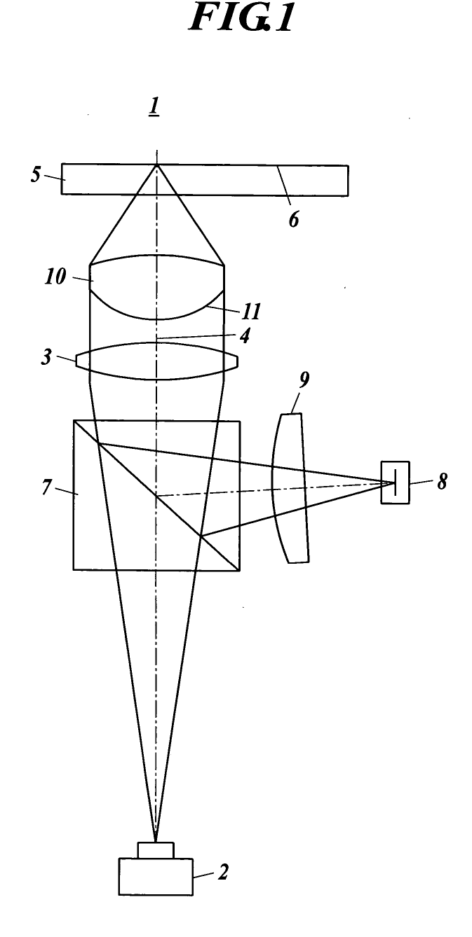

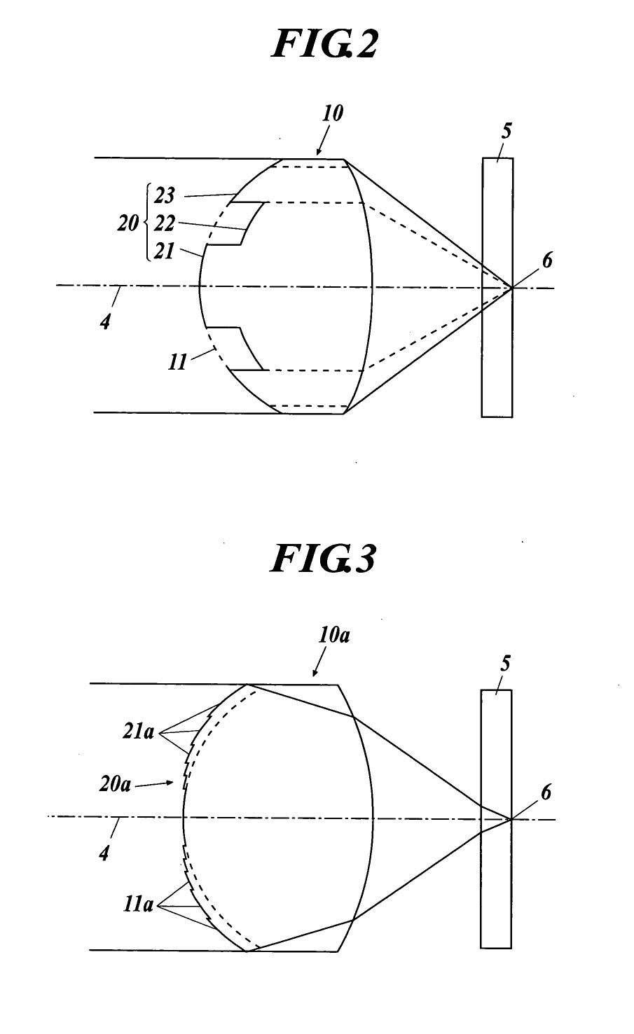

Hereinafter, description on plastic optical element and optical pickup apparatus of the present invention is given with reference to FIG. 1 and FIG. 2.

FIG. 1 is a view showing a schematic structure of the optical pickup apparatus 1 according to the present invention.

FIG. 2 is a cross sectional view showing a cross sectional view of objective lens 10 which is an optical element according to the present invention.

The optical pickup apparatus 1 of the present invention is an apparatus to reproduce and record information, concerning two types of optical information recording medium 5. Here, the two types are conventional DVD which applies light with wavelength of 650 nm (hereinafter referred to as conventional DVD), and next generation DVD which applies light with wavelength of 405 nm (hereinafter referred to as next generation DVD). Here, it is preferable that at least one of the wavelength of the light source is not less than 390 nm and not more than 420 nm.

The optical pickup apparatus 1 shown in FIG. 1 allows laser light (light) irradiated from light source 2 pass through mono optical elements such as collimating lens 3, object lens (plastic optical element) 10 having a minute structure as described later, and the like (The collimating lens and object lens in combination may be referred to as an optical unit). Then the light is collected at information recording surface 6 of the optical information recording medium 5 at optical axis 4, to form a light collecting spot. The reflective light from the information recording surface 6 is further reflected by deflection beam splitter 7, and forms beam spot on the light receiving surface of the detector 8 again through cylindrical lens 9.

The light source 2 is structured including laser diode, and according to conventional switching methods, it can select and irradiate between two types of light having wavelength of 650 nm and 405 nm.

The object lens 10 is an optical element having a fine structure, and is prepared by molding the aforementioned cyclic olefin plastic by injection molding. The object lens, as shown in FIG. 2, is a mono optical element whose both sides are aspherical surfaces, wherein at an optical surface 11 on one side of them (on the light source side), there is an optical path difference applying structure 20 (fine structure), which applies a predetermined optical path difference to the predetermined light that passes through the optical surface 11.

Concerning the optical path difference applying structure 20, the optical surface 11 is structured by three orbicular lens surface (hereinafter referred to as first orbicular lens surface 21, second orbicular lens surface 22, and third orbicular lens surface 23 respectively from the inner side) with the optical axis 4 in the center. Among the three orbicular lens surfaces 21 through 23, adjacent orbicular lens surfaces 21 through 23 have different refractive power.

The first orbicular lens surface 21 and the third orbicular lens surface 23 are on the same optical surface 11, and the second orbicular lens surface is a surface which is moved in parallel from the optical surface 11.

The first orbicular lens surface 21 collects light with wavelength of both 650 nm and 405 nm to the spot, the second orbicular lens surface 22 collects light with wavelength of 650 nm, which corresponds to conventional DVD, to the spot, and the third orbicular lens surface 23 collects light with wavelength of 405 nm, which corresponds to next generation DVD, to the spot. Then, spot light collected by each of the orbicular lenses 21 through 23 are collected to the same position on the information recording surface 6.

Here, in FIG. 2, the first orbicular lens surface 21 and the third orbicular lens surface 23 are provided on the same optical surface 11, however, the first and the third orbicular lens surfaces 21 and 23 do not have to be provided on the same optical surface. In addition, the second orbicular lens surface 22 is a surface which is moved in parallel from the optical surface 11, however, it may not be a surface which moved in parallel. Further, the three orbicular lens surfaces 21 through 23 may be five, and it can be in other numbers as long as it is three or more.

Concerning the object lens 10, since the aforementioned cyclic olefin plastic is applied, the plastic is certainly spread to the portions of the metal molds that correspond to the boundary of the first orbicular lens surface 21, the second orbicular lens surface 22, and the third orbicular lens surface 23, when molding by injection of molten plastic. Therefore, the object lens is provided with the optical path difference applying structure 20 with high degree of precision.

Within the effect of the optical path difference applying structure 20 that is formed as aforementioned, concerning a plurality of types of optical information recording medium 5 such as the conventional DVD and next generation DVD, the object lens 10 can collect the light irradiated from the light source 2 to the information recording surface 6, and can collect the light reflected from the information recording surface 6 to the detector 8 with high reliability. In addition, since the cyclic olefin plastic which structures the object lens 10 has a high light transmittance such as 85% or more, the above mentioned collection of light can be conducted with high conversion. Therefore, power consumption of the light source 2 can be lessened, thus enables to decrease power consumption of the optical pickup apparatus 1 as a whole.

In addition, since the cyclic olefin plastic contains antioxidant, even when transmitting light with wavelength of 405 nm to reproduce and record information of the next generation DVD, white turbidity or change in refractive index seldom occurs. Therefore, the optical pickup apparatus 1 can be operated within high pickup characteristic for a long period.

In addition, since the charging characteristic is low, under the condition where the object lens is placed, adhesion of dust or stain can be suppressed, and the optical characteristic can be maintained for a long period of time, therefore enables to obtain optical element with excellent durability and reliability.

Here, the object lens 10 according to the present invention is not limited to a structure including the above mentioned optical path difference applying structure 20, for example, and may have objective lenses 10a through 10e including optical path difference applying structures 20a through 20e, as shown in FIG. 3 through FIG. 7.

As shown in FIG. 3, optical path difference applying structure 20a of the object lens 10a is structured by a plurality of orbicular zone plates 21a with the optical axis 4 in the center, wherein the cross sectional surface of the plurality of orbicular zone plates 21a have saw-tooth appearance and optical surface 11a of each zone plate 21a is a non-continuous surface. In addition, the plurality of orbicular zone plates 21a are formed so that the thickness increases within the distance from the optical axis 4. The object lens 10a shown in FIG. 3 is what is called diffractive lens.

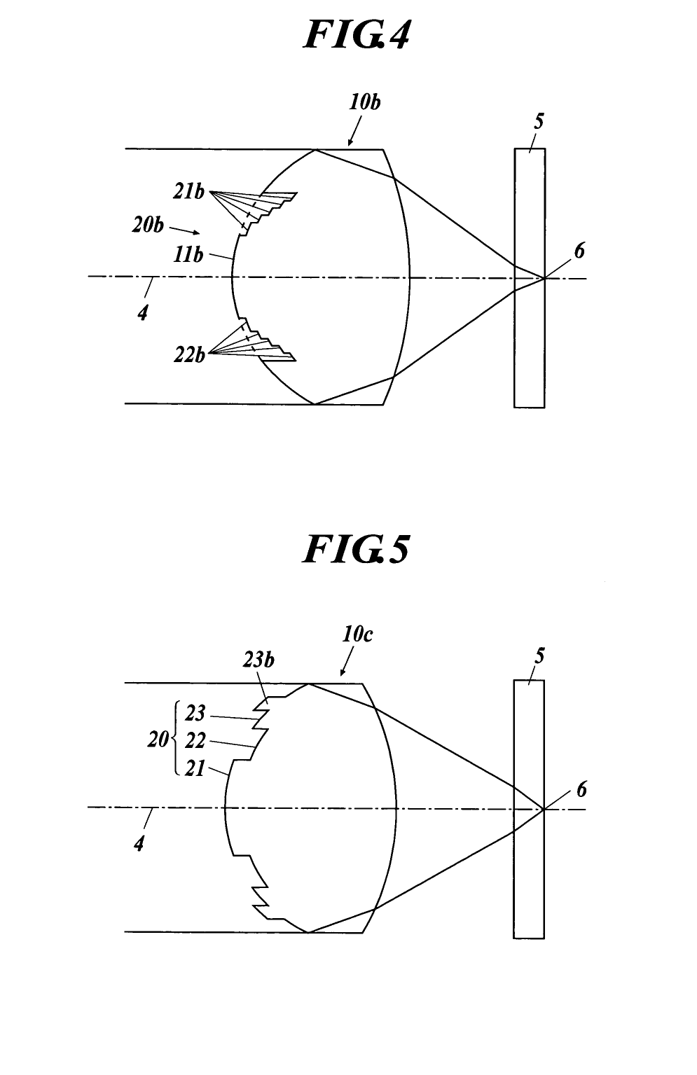

As shown in FIG. 4, optical path difference applying structure 20b of the object lens 10b is structured by a plurality of salient portions of orbicular zone 21b that causes phase difference, that are placed concentrically with the optical axis 4 in the center. The salient portions of orbicular zone 21b is formed in five, on one side, with the optical axis 4 as in center (the upper and lower optical surfaces, concerning the optical axis 4 in center, as shown in FIG. 4), among the optical surface 11b. In addition, the adjacent salient portions of orbicular zone 21b are continuously integral with each other, and the cross sectional surface of each of the salient portions of orbicular zone 21b as a whole have stair-like appearance. Further, the optical surface 22b forming each of the salient portions of orbicular zone 21b is a surface which is moved in parallel from the optical surface 11b. The object lens 10b shown in FIG. 4 is what is called phase difference lens.

Here, in FIG. 4, the adjacent salient portions of orbicular zone 21b are continuously integral with each other, and the cross sectional surface as a whole have stair-like appearance, however, it may be a structure with salient portions of orbicular zone 21b independently provided on the optical surface 11b (in this case, it becomes the same structure as the object lens 10 shown in FIG. 2). In addition, in FIG. 4, the salient portions of orbicular zone 21b were placed concentrically, however, as shown in FIG. 5, it may be an object lens 10c that includes salient portions of orbicular zone 23b on the third orbicular lens surface 23 of FIG. 2 (in FIG. 5, the same symbols were applied to the structure portions that are the same with FIG. 2).

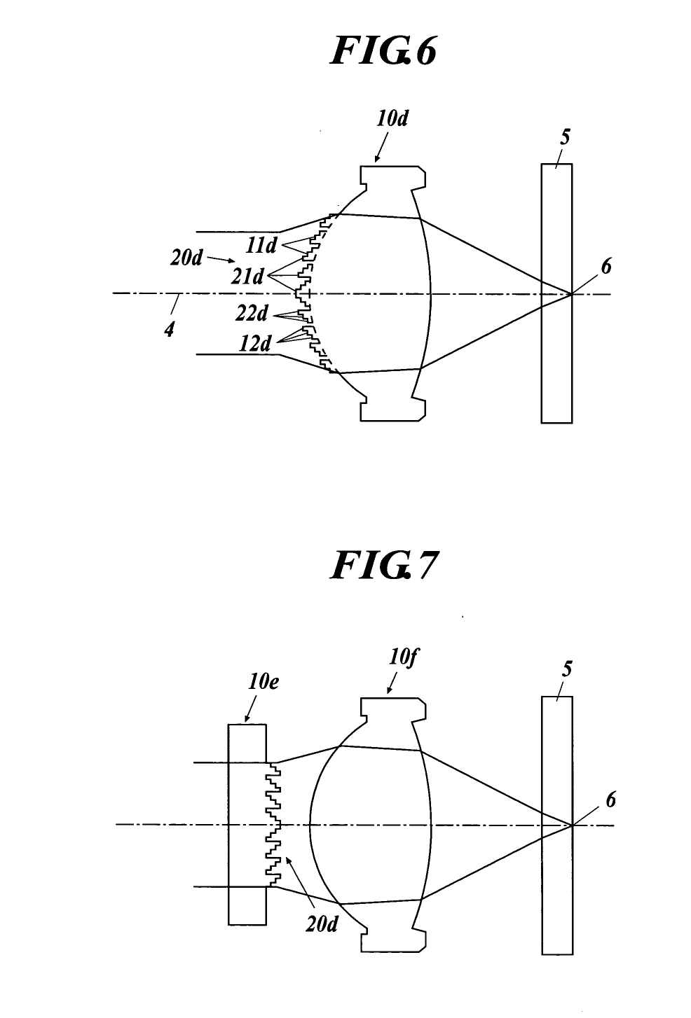

As shown in FIG. 6, optical path difference applying structure 20d of the object lens 10d is structured by a plurality of orbicular zone plates 21d with the optical axis 4 in the center, wherein the cross sectional surface of the plurality of orbicular zone plates 21d have saw-tooth appearance and optical surface 11d of each zone plate 21d is a non-continuous surface. In addition, the cross sectional surface of each of the orbicular zone plates 21d have stair-like appearance as shown in 22d, wherein three stages follow in the direction of the optical axis, optical surface 12d of each stage of 22d is non-continuous, and is orthogonal to the optical axis 4.

Here, the object lens 10d shown in FIG. 6 may be, as shown in FIG. 7 for example, structured independently with a hologram optical element (HOE) 10e including the same optical path difference applying structure 20d of FIG. 6, and the object lens 10f. In this case, the hologram optical element 10e uses a tabular optical element, and optical path difference applying structure 20d is provided on the surface of the object lens 10f of the optical element.

Here, the optical pickup apparatus 1 according to the present invention may reproduce and record information for three types of optical information recording medium 5 such as CD, conventional DVD, and next generation DVD. The combination of optical information recording medium 5 which is to be reproduced and recorded the information by the optical pickup apparatus 1 is a matter of design, and is designed arbitrarily.

### EXAMPLE

The present invention will be explained in detail by the embodiments hereinafter, however, the present invention is not limited to such embodiments.

### Manufacturing Example 1

After replacing the internal of stainless autoclave thoroughly with Nitrogen, 1000 parts by weight of dry cyclohexane is added, ant the internal is replaced with ethylene gas. Subsequently, 200 parts by weight of tetracyclo[4.4.0.1^{2,5}.1^{7,10] 3}-dodecene (hereinafter abbreviated as “TD”), 0.037 parts by weight of methyl aluminoxane (MAO) as aluminum atom equivalent, 0.003 parts by weight of bis(cyclopentadienyl)zirconium dichloride were added to the autoclave.

Within circulation of ethylene gas at flow late of 50 liters/hr, polymerization reaction was conducted for ten hours under conditions of 25 degrees Celsius, atmospheric pressure. Polymerization was terminated by addition of small amount of isobutyl alcohol, and the polymer was completely precipitated by introducing the reaction solution into mixed solvent of acetone/methanol. The copolymer was filtered and dried for 48 hours under reduced pressure at 80 degrees Celsius to provide plastic 1.

### Manufacturing Example 2

Plastic 2 was obtained by the same procedure as manufacturing example 1, except that norbornene was used in place of TD.

### Embodiment 1 Comparison Example

Plastic 1 obtained by manufacturing example 1 and pentaerythritoldistearate as surfactant in proportion ratio of 0.5 parts by weight were added to twin screw extruding machine (product of Toshiba Machine, Co., LTD, TEM-35B, screw diameter 37 mm, L/D=32, rotation speed 150 rpm, plastic temperature 240 degrees Celsius, feed rate 10 kg/hr), kneaded, and formed into pellet. The obtained pellet was removed of moisture by drying for two hours at 70 degrees Celsius by hot-air drying machine within air ventilation. Subsequently, by an injection molding machine (product of Fanuc LTD., AUTOSHOT MODEL 30A), the dried pellet was injection molded under conditions of cylinder temperature 280 degrees Celsius, mold temperature 80 degrees Celsius, primary injection pressure 98.1 Mpa, and secondary injection pressure 78.4 Mpa, into a base plastic substance with the size of 10 cm×10 cm and thickness of 3 mm. Thus, a formed plate 1 is obtained.

### Embodiment 2

Plastic 1 obtained by manufacturing example 1, 0.5 parts by weight of pentaerythritoldistearate as surfactant, and 0.1 parts by weight of tetraxis(methylene-3-(3′,5′-di-t-butyl-4′-hydroxyphenylpropionate))methane as phenolic stabilizer were added, and the following procedure was conducted as the same as embodiment 1, thus formed plate 2 was obtained.

### Embodiment 3

The same procedure as the embodiment 2 was conducted except that 0.1 parts by weight of tris(2,4-di-t-butylphenyl)phosphite as phosphorous stabilizer was used in place of tetraxis (methylene-3-(3′,5′-di-t-butyl-4′-hydroxyphenylpropionate))methane as phenolic stabilizer, thus formed plate 3 was obtained.

### Embodiment 4

The same procedure as the embodiment 2 was conducted except that 0.1 parts by weight of bis(2,2,6,6-tetramethyl-4-piperidyl)sebacate as hindered amine type stabilizer was used in place of tetraxis (methylene-3-(3′,5′-di-t-butyl-4′-hydroxyphenylpropionate))methane as phenolic stabilizer, thus formed plate 4 was obtained.

### Embodiment 5

The same procedure as embodiment 4 was conducted except that 0.1 parts by weight of Electrostripper AC, a product of Kao Corporation, was added as an antistatic agent 1. Thus formed plate 5 was obtained.

### Embodiment 6

The same procedure as embodiment 4 was conducted except that 0.1 parts by weight of indium oxide was added as an antistatic agent 2. Thus formed plate 6 was obtained.

### Embodiment 7

The same procedure as embodiment 4 was conducted except that a coating layer of Cytop, a product of Asahi Glass Co., LTD., was provided to the formed plate 4 as an antistatic agent containing coating. Thus formed plate 7 was obtained.

### Embodiment 8

The same procedure as embodiment 2 was conducted except that the plastic 2 was used in place of the plastic 1. Thus formed plate 8 was obtained.

### Embodiment 9

The same procedure as embodiment 4 was conducted except that the plastic 2 was used in place of the plastic 1. Thus formed plate 9 was obtained.

Next, concerning the formed plates obtained by the procedures of embodiment 1 through embodiment 9, fusion characteristic and optical characteristic were evaluated according to the method described below.

[Evaluation of Plastic Formed Product]

(Measurement of Melt Index)

Concerning each of the plastic optical elements, measurement was conducted according to the aforementioned method.

(Measurement of Friction-Charged Electrostatic Potential)

Under the environment where temperature is 23 degrees Celsius and humidity is 40%, measurement was conducted according to the aforementioned method, using a plastic plate of 10 cm×10 cm×3 mm.

(Evaluation of Colorability and Transparency for the Formed Product)

Concerning the aforementioned formed products, transmission for a light flux having a wavelength of 405 nm was measured, and color tone through transmitted light was observed. Subsequently, colorability and transparency was evaluated according to the following criterion.

(Evaluation of Light Resistance)

In a constant-temperature and constant-humidity chamber within environment of 80 degrees Celsius and 55% RH, by using an optical pickup apparatus shown in FIG. 1, a light with wavelength of 405 m as a circle spot of 1 mm diameter was continuously irradiated from laser diode 2 onto each of the formed plates. Subsequently, the portions where laser was irradiated were observed, and evaluation on (1) degree of stain, (2) transparency effected by white turbidity (degree of coloring), and (3) form stability were conducted within the following criterion.

Here, the symbols of I, II, and III stand for the observed results as described below.

(1) Degree of Stain

I: No adhesion of stain on the surface is observed after irradiation.

II: Adhesion of stain on the surface is observed. It is usable concerning the optical characteristic, however, appearance is not good.

III: Adhesion of stain on the surface is observed. There is disadvantage concerning the optical characteristic.

(2) Degree of Coloring

I: No white turbidity is observed on the portion where laser was irradiated after irradiation.

II: A slight white turbidity is observed on the portion where laser was irradiated after irradiation. However, it is still in the allowable range concerning practical use.

III: White turbidity is observed on the portion where laser was irradiated after irradiation. There is problem in practical use.

(3) Form Stability

I: No deformation is observed on the portion where laser was irradiated after irradiation.

II: A slight deformation is observed on the portion where laser was irradiated after irradiation. However, it is still in the allowable range concerning practical use.

III: Deformation is observed on the portion where laser was irradiated after irradiation. There is problem in practical use.

(Evaluation of Heat Resistance)

Heat resistance was evaluated by glass transition point (Tg) measured by DSC (which is a product of Seiko Instruments INC., DSC 200).

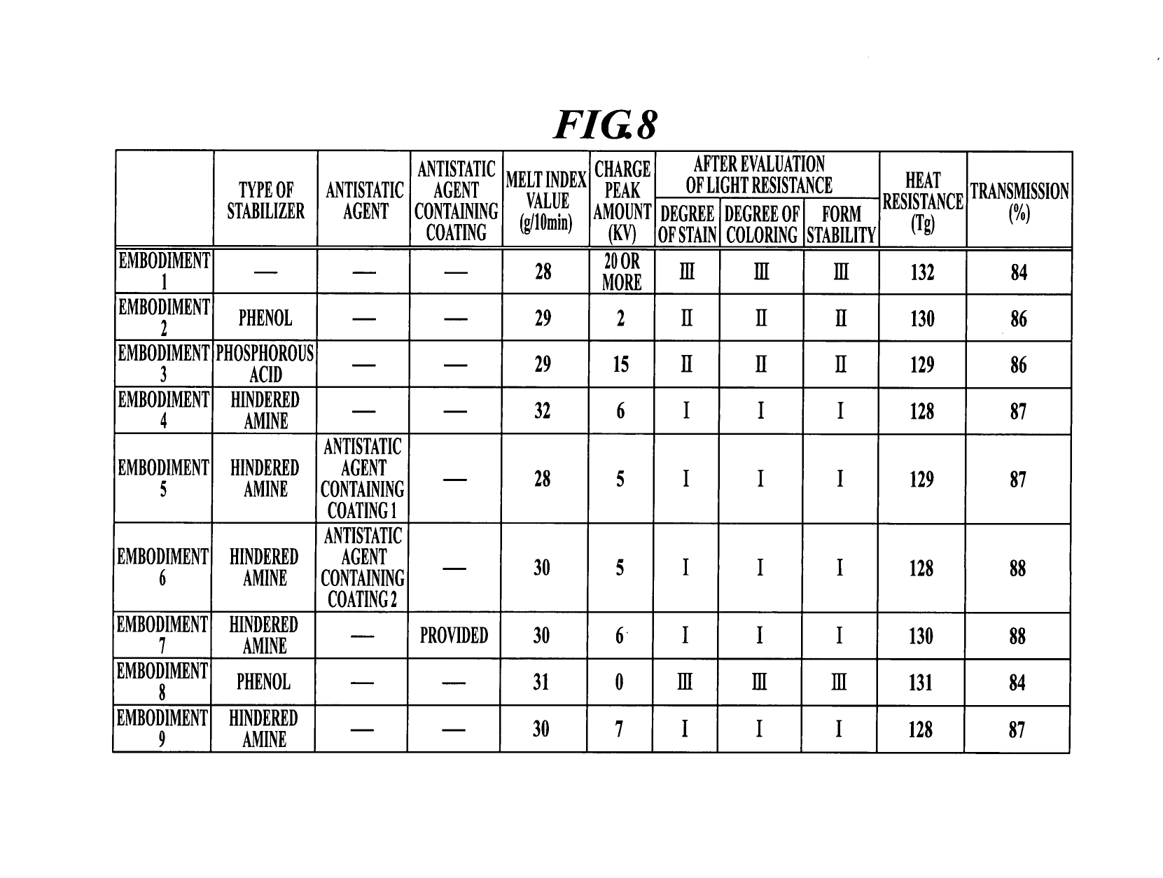

FIG. 8 is a table that shows result of conducting evaluation of fusion characteristic and optical characteristic, concerning the formed plates obtained by embodiment 1 through embodiment 9, within the aforementioned method.

As shown in the figure, according to the formed product of the present invention, despite successive irradiation for a long time, a few white turbidity by irradiation, suppression of appearance stain due to environment, and maintenance of transparency were achieved. Further, both good liquidity and high Tg were obtained.

Furthermore, optical elements (object lenses) which have configurations shown in FIGS. 2-7 were prepared by using the same composition as that of the formed plates described in Embodiments 1-9 and by injection molding, and then each of optical pickup apparatuses which have a structure shown in FIG. 1. Thereafter, recording and reproducing were conducted on a next generation DVD by using light with wavelength of 405 nm due to a laser diode by each of optical pickup apparatuses.

As a result, according to the optical pickup apparatuses using optical elements shown in Embodiments 2-7 and 9, despite successive irradiation for a long time and a few stain for every one, and therefore a pickup characteristic in the allowable range concerning practical use were observed. On the contrary, according to using optical elements shown in Comparative Examples 1 and 8, an appearance stain, lowering of transparency and therefore lowering of pickup characteristic were observed.

According to the result shown in FIG. 8, it is understood that the charge peak amount of +2 kV to +15 kV causes no problem in practical use, and further, the charge peak amount of +3 kV to +10 kV provides a good light stability and a good transmission, and therefore a more preferable pickup characteristic.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An optical element, comprising:
plastic compound,
wherein the optical element is made by shaping the plastic compound,
wherein charging characteristic of the optical element is not less than +2 kV and not more than +15 kV, and
transmission of the optical element for a light flux having a wavelength of 405 nm is not less than 85%.

2. The optical element of claim 1, wherein charging characteristic of the plastic compound is not less than +2 kV and not more than +15 kV, and
transmission of the plastic compound for a light flux having a wavelength of 405 nm is not less than 85%.

3. The optical element of claim 1, wherein the plastic compound comprises at least one kind of hindered amine stabilizer.

4. The optical element of claim 1, wherein the plastic compound comprises at least one kind of antistatic agent.

5. The optical element of claim 1, wherein the plastic compound comprises polymer A obtained from addition polymerization of α-olefin of which number of carbon atoms is 2 to 20 and cyclic olefin illustrated in a formula (1), or polymer B obtained from additional polymerization of α-olefin of which number of carbon atoms is 2 to 20 and cyclic olefin illustrated in a formula (2), 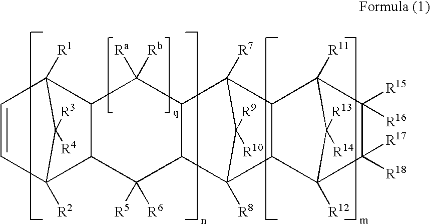
wherein in the formula (1), n represents 0 or 1, m represents 0 or integer which is not less than 1, q represents 0 or 1, R1-R18, Ra and Rb represent hydrogen atom, halogen atom or hydrocarbon group respectively and independently, R15-R18 can bind with each other to form monocycle or polycycle, the monocycle or the plycycle within the above parenthesis can comprise double bond, and R15 and R16 or R17 and R18 can form an alkylidene group, 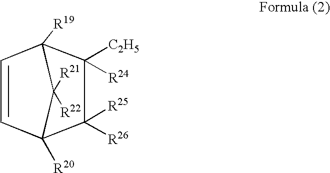
where in the formula (2), R19-R26 represent hydrogen atom, halogen atom or hydrocarbon group respectively and independently.

6. The optical element of claim 5, wherein the polymer A or the polymer B comprises at least one kind of antistatic agent by 0.001 to 2.0 parts by weight for 100 parts by weight of the polymer A or the polymer B.

7. The optical element of claim 1, wherein the plastic compound comprises at least one kind, or more than two kinds of stabilizer chosen among phenolic stabilizer, phosphorous stabilizer, and sulfur stabilizer.

8. The optical element of claim 1, wherein the optical element comprises a layer comprising at least one kind of antistatic agent.

9. The optical element of claim 4, wherein the antistatic agent is at least one kind chosen among anion type antistatic agent, cation type antistatic agent, nonion type antistatic agent, ampholyte ion type antistatic agent, polymer antistatic agent, and conductive particle.

10. The optical element of claim 9, wherein average particle diameter of the conductive particle is not more than 100 nm.

11. The optical element of claim 10, wherein the conductive particle is at least one of cerium oxide, indium oxide, tin oxide, antimony oxide, and silicone oxide.

12. The optical element of claim 1, wherein melt index (MI) value of the plastic compound measured under conditions of 260 degrees Celsius and 2.16 kg load is in a range of
20<MI (g/10 min)<60
and at least one optical surface is provided with a predetermined fine structure.

13. The optical element of claim 1, wherein the optical element is applied to an optical pickup apparatus capable of light condensing.

14. The optical element of claim 1, wherein charging characteristic of the optical element is not less than +3 kv and not more than +10 kV.

15. An optical pickup apparatus to conduct at least either reproducing or recording information within an optical information recording medium, comprising:
a light source to irradiate a light flux; and
an optical unit to condense the light flux from the light source on information recording surface of the optical information recording medium; wherein
the optical unit comprises at least one optical element; and
the optical element is made by shaping a plastic compound, charging characteristic of the optical element is not less than +2 kV and not more than +15 kV, and transmission of the optical element for a light flux having a wavelength of 405 nm is not less than 85%.

16. The optical pickup apparatus of claim 15, wherein the light source irradiates a light flux with wavelength of 390-420 nm.
